(19) United States
(12) Patent Application Publication
(10) Pub. No.: US 2006/0187069 A1
(43) Pub. Date: Aug. 24, 2006

(54) Alarm device for liquid circulation system

(75) Inventor: Qiang-Fei Duan, Chung-Ho City (TW)

Correspondence Address: HDSL, 4331 STEVENS BATTLE LANE, FAIRFAX, VA, 22033, US

(73) Assignee: Cooler Master Co. Ltd.

(21) Appl. No.: 11/060,441

(22) Filed: Feb. 18, 2005

(51) Int. Cl. G08B 21/00; G01N 21/86; G01N 21/85

(52) U.S. Cl. 340/606; 340/619; 250/573; 250/559.42

(57) ABSTRACT

An alarm device for use in a liquid circulation system. The alarm device includes an optical detection unit, which includes an optical emitter that generates light beam to penetrate through a transportation media of the liquid circulation system, and an optical receiver that is positioned opposite to the optical emitter for receiving the light beam penetrated through the transportation media. The alarm device further includes a decision circuit, which is electrically coupled to the optical receiver for excerpting therefrom electronic signals corresponding to the intensity of light beam received by the optical receiver. The decision circuit further determines whether the transportation media is in a normal state. If the transportation media is in an abnormal state, a control signal is generated to drive the alarm sending out alert messages. The alarm device described above is assembled in a box and is securely installed to a predetermined position of the transportation media of the liquid circulation system.

### BACKGROUND OF THE INVENTION

The present invention relates generally to an alarm device for a liquid circulation system, and more particularly to an alarm system that employs optics to examine the status of liquid circulation in the liquid circulation system. The alarm system is configured to send out alarm message when there is no or less than a predetermined amount of fluid flow in the circulation system. This alarm device is of a non-contact device, which is structurally simple and less costly. Furthermore, the speed and accuracy of examination is also largely enhanced.

Conventional examination or alarm device applied in the liquid circulation system is primarily installed in the pipe of liquid flow of the liquid circulation system. The examination device contacts the liquid to detect the quantity and speed of liquid flow. Such kind of examination requires a physical connection between the examination device and the pipe of the liquid circulation system, which increases the complexity of assembly and the possibility of leaking. In addition, since the examination device contacts the liquid directly, one needs to consider the properties of the liquid, such as the pH value of the liquid. Therefore, it is highly difficult to perform maintenance tasks and is relatively more costly.

The advancement of electronic technology has evolved a need for cooling the operational electronic devices that produces a huge amount of heat. Such operational electronic device includes, for example, a central processing unit. In particular, a water cooling system is often deployed on the heat generating electronic device. The water cooling system includes at least a water cooler, a circulation pump, and a cooling base, which are mutually connected by pipes to form closed circuits for liquid circulation. By using the circulation pump, the low temperature liquid flows into the cooling base through the pipe. After a thermal exchange is performed, the high temperature liquid flows out to the pipe, sending to the water cooler for performing another thermal exchange to form low temperature liquid. The low temperature liquid is then flowed to the water pump for performing another water cooling cycle. However, such kind of water cooling device applicable to the heat generating electronic device is often installed in a restricted space. The size thereof is required to be as small as possible. In addition, since the currently commercially available examination device is voluminous, there is no add-on device for examining the status of liquid flow for the water cooling system. Nevertheless, temperature of an electronic device is one of the most significant factors that affect the operation thereof. For this reason, to develop an examination device with a miniaturized volume and yet capable of examining the status of cooling water supply is the primary objective of the present invention.

### BRIEF SUMMARY OF THE INVENTION

The present invention is to provide an alarm device for use in a liquid circulation system, which can examine the status of liquid flow in the liquid circulation system. When there is no or a reduced amount of liquid flow is detected in the transportation media of the liquid circulation system, an alerting message is produced. Further, the alarm device of the present invention is advantageous in that the structure is simple, the cost is lower, while the examination speed and accuracy is enhanced.

In order to achieve the above and other objectives, the alarm device for a liquid circulation system of the present invention includes an optical emitter, an optical receiver, a decision circuit, and an alarm. The optical receiver is disposed corresponding to the optical emitter. The decision circuit is electrically coupled to the optical receiver for excerpting therefrom electronic signals. When abnormality is detected from the optical received, the decision circuit generates a control signal to drive the alarm sending out alerting messages.

### BRIEF DESCRIPTION OF THE DRAWINGS

FIG. 1 is a block diagram illustrating the alarm device, in accordance with one embodiment of the present invention.

FIG. 2 is a perspective view illustrating the alarm device of the present invention installed on a liquid circulation system.

FIG. 3 is an explosive view illustrating the alarm device of the present invention in connection with the liquid circulation system.

FIG. 4 is a schematic diagram illustrating the optical detection unit of the alarm device of the present invention.

FIG. 5 is a circuit diagram of the alarm device, in accordance with one embodiment of the present invention.

FIG. 6 is a sectional view of a pipe, in accordance with the first embodiment of the present invention.

FIG. 7 is a sectional view of a pipe, in accordance with the second embodiment of the present invention.

FIG. 8 is a sectional view of a pipe, in accordance with the third embodiment of the present invention.

FIG. 9 is a sectional view of a pipe, in accordance with the fourth embodiment of the present invention.

FIG. 10 is a block diagram of the alarm device showing a normal state.

FIG. 11 is a block diagram of the alarm device showing an abnormal state.

FIG. 12 is an alarm device of the present invention applied for a water cooling system.

### DETAILED DESCRIPTION OF THE INVENTION

In order to better understanding the features and technical contents of the present invention, the present invention is hereinafter described in detail by incorporating with the accompanying drawings. However, the accompanying drawings are only for the convenience of illustration and description, no limitation is intended thereto.

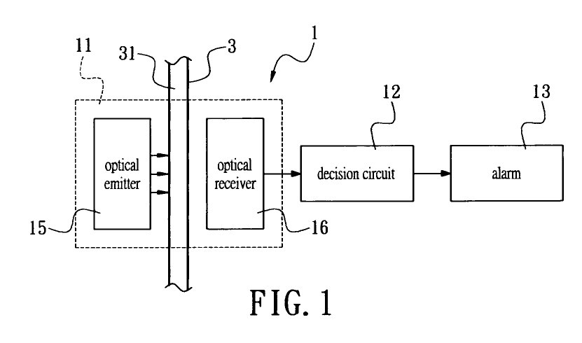

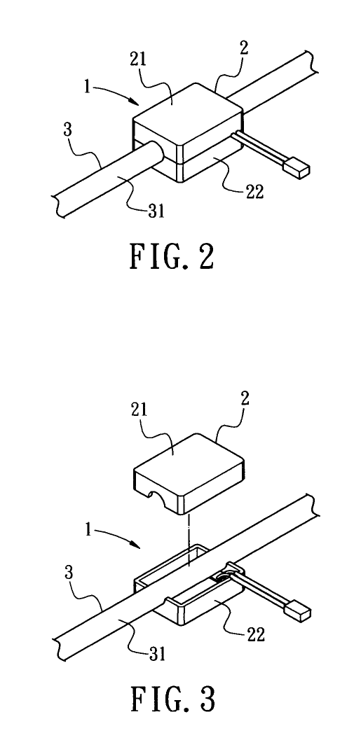

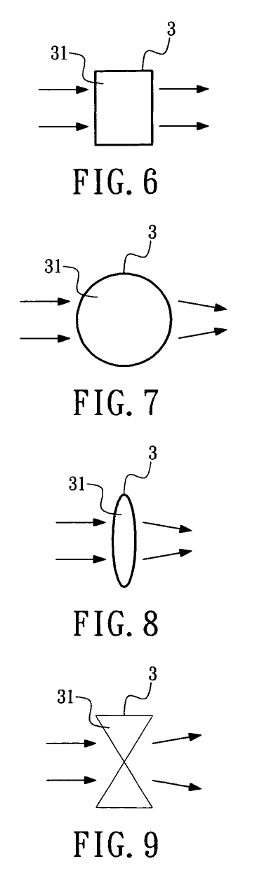

Referring to FIG. 1 to FIG. 11, a preferred embodiment of an alarm device for a liquid circulation system is illustrated. The alarm device 1 includes an optical detection unit 11, a decision circuit 12, and an alarm 13. As shown in FIG. 1, the alarm device 1 is assembled in a box 2 and securely installed in a liquid circulation system 3. In particular, the alarm device 1 is installed on a transportation media 31 along the path of liquid flow, as shown in FIG. 2.

The optical detection unit 11 includes an optical emitter 15 and an optical receiver 16, as shown in FIG. 3.

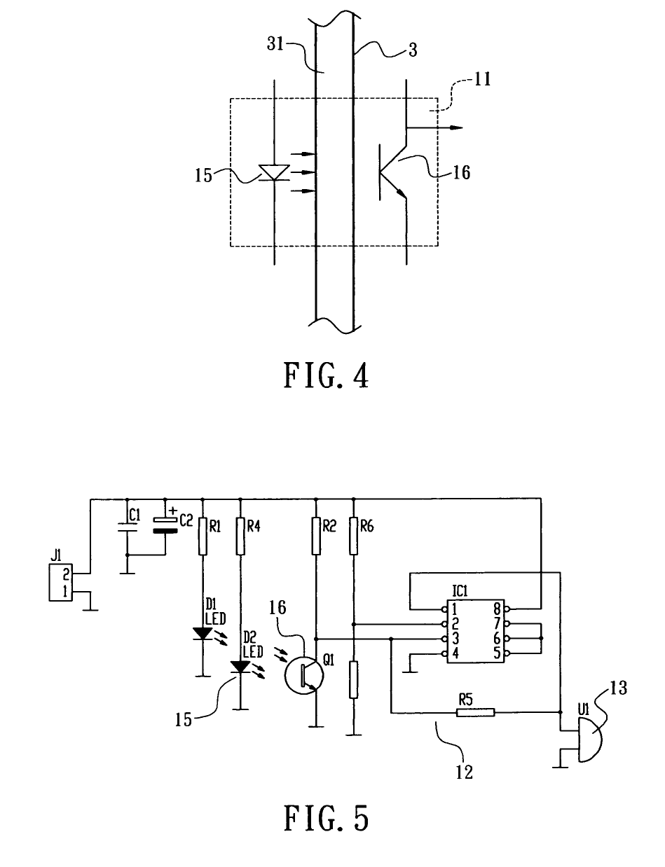

The optical emitter 15 generates and emits light beam, such that the light beam can pass through transportation media 31 along the path of fluid flow of the liquid circulation system 3, as shown in FIG. 2 and FIG. 4. In one particular embodiment of the present invention, the optical emitter 15 is one selected from a light emitting diode, an organic light emitting diode, a polymer light emitting diode, a resonant chamber light emitting diode, a laser light emitting diode, a vertical chamber surface emitting laser. The generated and emitted light beam can be of any color, however, preferably be red or infrared.

The optical receiver 16 described above is disposed relative to the optical emitter 15, and receives the light beam that passes through the transportation media 31 along the path of liquid flow of the liquid circulation system 3. Meanwhile, the optical receiver 16 outputs an electronic signal proportional to the strength of the received light beam. In one preferred embodiment of the present invention, the optical receiver 16 is an optical sensitive element.

The decision circuit 12 described above is electrically coupled to the output end of the optical receiver 16 so as to excerpt the output electronic signal. The decision circuit 12 determines whether the voltage of the output electronic signal increases or decreases, which corresponds to the increase or decrease of the light beam intensity. When such an abnormality occurs, an alarm driving signal is generated. The decision circuit 12 in one particular embodiment of the present invention is a logic circuit, as shown in FIG. 5.

The alarm 13 described above can be a loud speaker that produces alerting voice or noise, e.g. a buzzer, electrically coupled to the output end of the decision circuit 12.

The transportation media 31, where the alarm device 1 is installed thereon, disposed in the liquid circulation system 3 is either a pipe or a container that provides liquid to flow or be stored therein. In one particular embodiment, the transportation media 31 is a pipe, as shown in FIG. 2 and FIG. 3. Furthermore, the transportation media 31 can be of no particular shape. That is, the cross section of the transportation media 31 can be rectangular, circular, oval or triangular.

In one particular embodiment, the box 2 described above is composed of an upper box 21, and a lower box 22 combined with the upper box 21. In addition to containing the optical detection unit 11, the decision circuit 12 and the alarm 13 therein, the upper and the lower box 21, 22 can be used to clip on the transportation media 31 directly, as shown in FIG. 2 and FIG. 3.

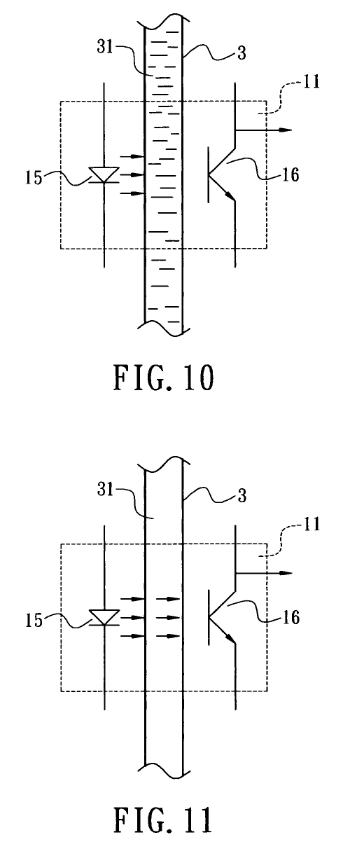

Accordingly, the alarm device 1 can be applied to a liquid circulation system such that the alarm device 1 is installed and assembled to a predetermined position of a transportation media 31 along the path of liquid flow, as shown in FIG. 2. The alarm device 1 employs a box 2 to securely install itself on a predetermined position of a transportation media 31 along a path of liquid flow of the liquid circulation system 3. The optical emitter 15 and the optical receiver 16 are positioned at two opposite sides of the transportation media 31 so as to allow the light beam generated from the light emitter 15 to pass through the transportation media 31. The transportation media 31 is said to be in a normal state, when there is a predetermined amount of liquid flowing therethrough the transportation media 31, as shown in FIG. 10. The transportation media 31 is said to be in an abnormal state, when there is no or less than a predetermined amount of liquid flowing therethrough, as shown in FIG. 11. After passing through the transportation media 31 and being received by the optical receiver 16, the intensity of light beam depends on the liquid flow in the transportation media 31. Electronic signals of different voltages is generated corresponding to the intensity of light beam received by the optical receiver 16. The electronic signals are then output to the decision circuit 12 to determine whether the transportation media 31 is in its normal or abnormal state The decision circuit 12 will output a control signal to the alarm 13, driving the alarm 13 to send out an alert voice or noise. Therefore, a non-contact optical examination device is obtained. In addition, by combining the optical element and the electronic logic circuit, the physical size of the alarm device 1 is miniaturized, the structure thereof is simplified, the cost thereof is lowered, and further, the speed, accuracy and sensitivity thereof are enhanced.

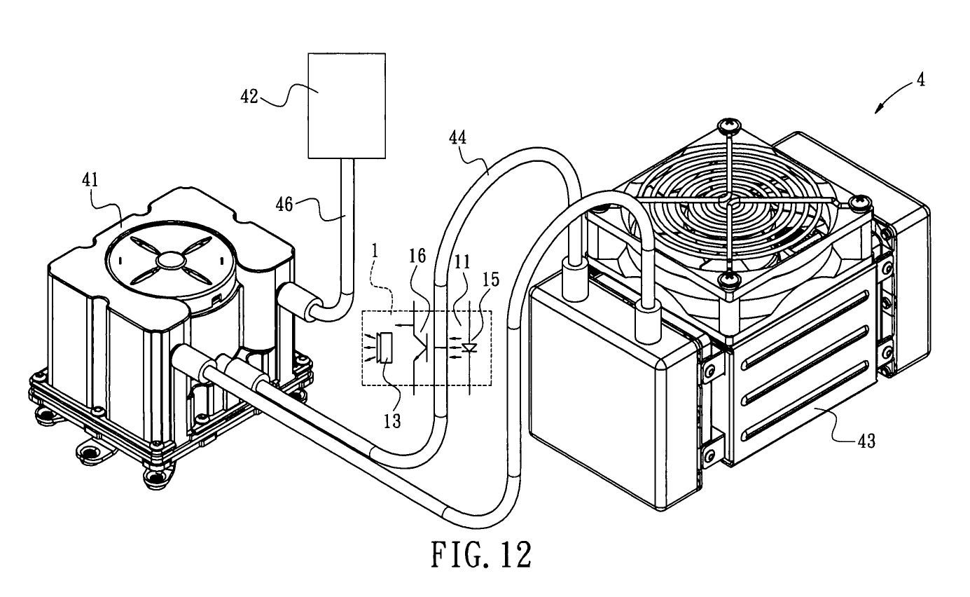

Referring further to FIG. 12, an alarm device applied to a water cooling system 4, in accordance with one preferred embodiment of the present invention is illustrated.

The water cooling system 4 is applied to a heat generating electronic device, such as a central processing unit. The water cooling system 4 includes a water cooler 41, a circulation pump 42, and a cooling base 43. The components of the water cooling system 4 are mutually connected with pipes 44 and water pipes 46 to form liquid circulation path, as shown in FIG. 12.

Similar to the embodiments set forth above, the alarm device 1 also includes an optical detection unit 11, a decision circuit 12, an alarm 13, and a box 2, as shown in FIG. 1 and FIG. 2. The optical detection unit 11 includes an optical emitter 15 and an optical receiver 16, as shown in FIG. 4.

The alarm device 1 described above is installed on a predetermined position of the pipe 44 or water pipe 46, as shown in FIG. 12. In addition, the optical emitter 15 and the optical receiver 16 are positioned at two opposite sides of the pipe 44 or the water pipe 46. In this manner, the light beam generated from the light emitter 15 can pass through the pipe 44 or the water pipe 46 to examine whether the cooling water is flowing through the pipe 44 or the water pipe 46. The intensity of light beam received y the optical receiver 16 will increase once there is no or a reduced amount of liquid flow passing through the pipe 44 or the water pipe 46. The optical receiver 16 then generates an electronic signal of relatively lower voltage to the decision circuit 12, thereby concluding that there is no or a reduced amount of liquid flow passing through the pipe 44 or water pipe 46. A control signal is output to drive the alarm 13 producing an alerting voice or noise, when such occasion occurs.

Since, any person having ordinary skill in the art may readily find various equivalent alterations or modifications in light of the features as disclosed above, it is appreciated that the scope of the present invention is defined in the following claims. Therefore, all such equivalent alterations or modifications without departing from the subject matter as set forth in the following claims is considered within the spirit and scope of the present invention.

What is claimed is:

1. An alarm device for use in a liquid circulation system, comprising:
an optical detection unit that generates electronic signals in accordance with the intensity of light beam penetrated through a transportation media of the liquid circulation system;
a decision circuit electrically coupled to the optical detection unit for excerpting the electronic signals generated from the optical detection unit and generating a control signal when the transportation media is in an abnormal state; and
an alarm electrically coupled to the decision circuit for generating an alert message in accordance with the control signal from the decision circuit.

2. The alarm device as recited in claim 1, wherein the optical detection unit further comprises an optical emitter and an optical receiver, the optical emitter and the optical receiver being positioned to opposite sides of the transportation media.

3. The alarm device as recited in claim 2, wherein the optical emitter is one selected from a light emitting diode, an organic light emitting diode, a polymer light emitting diode, a resonant chamber light emitting diode, a laser diode, a vertical chamber surface emitting laser, while the optical receiver is an optical sensitive device.

4. The alarm device as recited in claim 1, wherein the decision circuit is a logic circuit.

5. The alarm device as recited in claim 1, wherein the alarm is a loud speaker for generating alerting voice or noise.

6. The alarm device as recited in claim 1, wherein the transportation media on which the alarm device is installed is a pipe or a container, which can be of any shape such as rectangular, circular, oval and triangular, the alarm device being assembled in a box.

7. An examination device for a liquid circulation system, which comprises:
an optical emitter;
an optical receiver disposed corresponding to the optical emitter; and
a decision circuit electrically coupled to the optical receiver for excerpting therefrom electronic signals.

8. The alarm device as recited in claim 7, further comprising a alarm electrically coupled to the decision circuit for generating alerting messages.

9. An alarm device for a water cooling system, comprising:
a water cooling system;
a alarm device securely installed on a predetermined position of the cooling system, which comprising:
an optical emitter;
an optical receiver disposed corresponding to the optical emitter;
a decision circuit electrically coupled to the optical receiver for excerpting therefrom electronic signals and outputting a control signal in accordance with the electronic signals;
a alarm electrically coupled to the decision circuit for generating alerting messages in response to the control signal.

10. The alarm device as recited in claim 9, wherein the water cooling system comprises a water cooler, a circulation pump and a cooling base, which are mutually connected by pipes or water pipes, thereby forming a liquid circulation path.

11. The alarm device as recited in claim 9, wherein the alarm device is securely installed on a predetermined position of the pipe or the water pipe, whereby the optical emitter and the optical receiver are positioned at two opposite sides of the pipe or the water pipe.
